(19) United States
(12) Patent Application Publication
(10) Pub. No.: US 2022/0201139 A1
(43) Pub. Date: Jun. 23, 2022

(54) TELESCOPIC MOUNTS FOR IMAGING DEVICES

(71) Applicant: Hewlett-Packard Development Company, L.P., Spring, TX (US)

(72) Inventors: Shuang-Kun Zhu, Shanghai (CN); Lei Chen, Shanghai (CN); Li Nan Han, Shanghai (CN)

(21) Appl. No.: 17/594,133

(22) PCT Filed: May 5, 2019
(86) PCT No.: PCT/CN2019/085529

§ 371 Date: Oct. 4, 2021

(51) Int. Cl. H04N 1/00

(52) U.S. Cl. CPC H04N 1/00559; H04N 1/00496

(57) ABSTRACT

Examples of a telescopic mount for an imaging device are described herein. In an example, the telescopic mount includes a longitudinal body having a first end and a second end opposite to the first end. At the first end, a slot forming a mating feature is provided to detachably couple a component to the longitudinal body. At the second end, a locking feature is provided to lock the longitudinal body with a support element.

### BACKGROUND

Imaging devices, such as printers and scanners, can be used for transferring printing data on to a medium, such as paper, by a non-impact process. In order to allow a user to interface with such an imaging device, the imaging device is provided with a control panel. In one example, the control panel can be provided as a keypad having various buttons and keys, and in another example, the control panel can be provided as a touch-screen. The control panel allows the user to provide inputs to the imaging device, for instance, for selecting various functionalities of the imaging device for execution.

### BRIEF DESCRIPTION OF FIGURES

The detailed description is provided with reference to the accompanying figures, wherein:

FIG. 1 illustrates a schematic of an imaging device, according to an example;

FIG. 2A and FIG. 2B illustrate perspective views of the imaging device, according to an example;

FIG. 3 illustrate illustrates a schematic of a control panel assembly for the imaging device, according to an example;

FIG. 4 illustrates a schematic of a telescopic mount for the imaging device, according to an example;

FIG. 5 illustrates a perspective view of the telescopic mount, according to an example;

FIG. 6A and FIG. 6B illustrate a perspective view of the control panel assembly assembled with the imaging device, according to an example;

FIG. 7 illustrates a rear perspective view of a control panel for the imaging device, according to an example;

FIG. 8A and FIG. 8B illustrate the assembly of the control panel and the telescopic mount, according to an example.

It should be noted that the description and the figures are merely examples of the present subject matter and are not meant to represent the subject matter itself. Throughout the drawings, identical reference numbers may designate similar, but not identical, elements. The figures may not be to scale, and the size of some parts may be exaggerated to more clearly illustrate the example shown. Moreover, the drawings provide examples and/or examples consistent with the description; however, the description is not limited to the examples and/or examples provided in the drawings.

### DETAILED DESCRIPTION

Generally, a control panel of an imaging device is positioned with respect to the imaging device with due consideration to the ease of accessibility for a user. In addition, the imaging devices are also ergonomically designed which has a further bearing on the positioning of the control panel with respect to the imaging device. As an example, in few cases, the control panel can be provided as a separate interface detachably mounted on the imaging device and operably coupled to the imaging device via a wire or even wirelessly. In few other cases, the control panel can be provided as a part of the imaging device, for example, movably mounted on a frame of the imaging device.

For instance, in one design of the imaging device, the control panel can be positioned on a user-facing wall of the imaging device. The mounting of the control panel is done using a hinge, such as a friction hinge, so as to provide a swiveling motion to the control panel towards and away from the user-facing wall, for ease of access to the user. However, the provision of such a hinge for mounting can add to the cost of the imaging device. In addition, in such a design, a frame or housing of the imaging device has to be designed and manufactured in a manner that the control panel can be accommodated in the user-facing wall of the imaging device. With such designs, the manufacturing of the frame of the imaging device may be costly as it may not be achievable by regular manufacturing techniques and equipment. At the same time, the aesthetics of the imaging device may also be adversely affected. Further, owing to the ergonomics, various other components and parts of the imaging device that are to be accessed by the user may be provided on the same user-facing wall as the control panel is provided on. For instance, an input tray or an output tray of the imaging device may be provided on the user-facing wall and may have to be accommodated along with the control panel. In certain such imaging device designs, to accommodate various components, the control panel may be positioned at an offset from the frame and may even extend beyond the frame of the imaging device. Besides adversely affecting the aesthetics of the imaging device, the extended control panels are also prone to being damaged, for example, during operation or during transit. Accordingly, for instance, while transportation of such imaging devices, care has to be taken in packaging the imaging devices appropriately to prevent damage to the already damage-prone control panels. As a result, the cost of packaging as well as the cost of transportation may be high, with still a possibility of the control panels being damaged.

Approaches for providing a telescopic mount for imaging devices are described. The telescopic mount, in one example, can be used for mounting a control panel in a manner that the control panel can be accommodated within a frame or housing of the imaging device without affecting the aesthetics of the imaging device. Accordingly, in an aspect, the telescopic mount, having the control panel mounted thereon, is protractible (or withdrawn) and retractable (or inserted) with respect to the housing of the imaging device, allowing the control panel to be hidden when not in use. For instance, in a retracted position of the telescopic mount, the control panel can be flush with the housing and can be positioned to be in a recess in the housing of the imaging device provided for accommodating the control panel.

In one example, the housing of the imaging device can be provided with an opening to accommodate the telescopic mount and the control panel, as mentioned earlier, can be mounted to the imaging device using the telescopic mount. The telescopic mount may be disposed in the opening in the housing and may be slidable in the opening with respect to the housing for retractability and protractibility. In an example, the opening may be provided in a recess under a top cover of the imaging device, such that it may accommodate a linear sliding motion of the control panel with respect to the housing. Accordingly, the access to the control panel can be provided by a simple linear movement of the control panel, while at the same time the control panel can be easily and conveniently accommodated in the recess when not in use. Accordingly, given the design of the telescopic mount, the control panel is accommodated in the recess in such manner that the control panel remains protected from being damaged, for example, during operation or during transit.

In said example, the telescopic mount can include a longitudinal body having a first end and a second end opposite to the first end. The longitudinal body of the telescopic mount allows for telescopic slidable motion with respect to the housing. For coupling the control panel and the telescopic mount, the control panel may include an engagement feature and the telescopic mount can include a slot forming a mating feature at the first end to detachably couple to the engagement feature of the control panel. Further, at the second end, the telescopic mount can include a locking feature to stop the telescopic mount from being withdrawn from the housing during operation.

The telescopic mount of the present subject matter has a simple design and construction with few moving parts. Therefore, the telescopic mount is low-cost and is less prone to damage or early replacement. Further, owing to simple design and construction, the manufacturing of the telescopic mount is simple. In addition, the housing of the imaging device can be easily modified, without substantial cost, to accommodate the telescopic mount, for instance, simply by cutting an opening and providing a few minor constructional features thereon. At the same time, the aesthetics of the imaging device remain unaffected even with the provision of the control panel mounted to the telescopic mount, while various components, such as an input tray or an output tray of the imaging device, can be accommodated along with the control panel due to the design of the telescopic mount as described herein.

The above aspects are further described in conjunction with the figures, and in associated description below. It should be noted that the description and figures merely illustrate principles of the present subject matter. Therefore, various arrangements that encompass the principles of the present subject matter, although not explicitly described or shown herein, may be devised from the description and are included within its scope. Additionally, the word “coupled” is used throughout for clarity of the description and can include either a direct connection or an indirect connection.

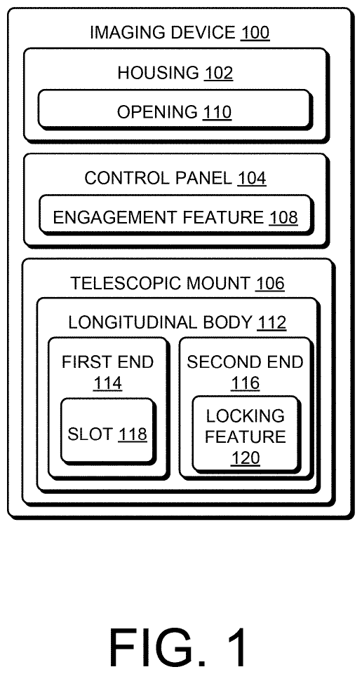

FIG. 1 illustrates a schematic of an imaging device 100, in accordance with an example of the present subject matter. In one example, the imaging device 100 can be a mufti-functional printer, a scanner, a fax machine, a three-dimensional (3D) printer or a combination thereof. In said example, the imaging device 100 can include a housing 102 and a control panel 104 to be mounted to the housing 102. According to an aspect, the imaging device 100 can be designed to accommodate a component, such as the control panel 104, at a support element, such as the housing 102, in such a manner that the component can blend with the imaging device 100 without affecting aesthetics of the imaging device 100, while, at the same time, the component can be conveniently and ergonomically used by a user. The imaging device 100 can further include a telescopic mount 106 using which the control panel 104 can be mounted to the housing 102. Accordingly, the control panel 104 can include an engagement feature 108 which can engage with the telescopic mount 106 for coupling the control panel 104 to the telescopic mount 106. In addition, the housing 102 can include an opening 110 in which the telescopic mount 106 can be disposed for, in turn, mounting the control panel 104 to the housing 102.

Further, the telescopic mount 106 can include a longitudinal body 112 and can be, as mentioned earlier disposed in the opening 110, for being telescopically slidable with respect to the housing 102 along the longitudinal body 112. The longitudinal body 112 can have a first end 114 and a second end 116 opposite to the first end 114. At the first end 114, the longitudinal body 112 can include a slot 118 forming a mating feature to detachably couple to the engagement feature 108 of the control panel 104. Further, at the second end 116, the longitudinal body 112 can include a locking feature 120 to lock the longitudinal body 112 with the housing 102 in a protracted or withdrawn position of the telescopic mount 106. For example, in the protracted position, the telescopic mount 106 can be substantially but not completely withdrawn from the housing 102 so that the control panel 104 is drawn away from the housing 102, for instance, for convenience of the user.

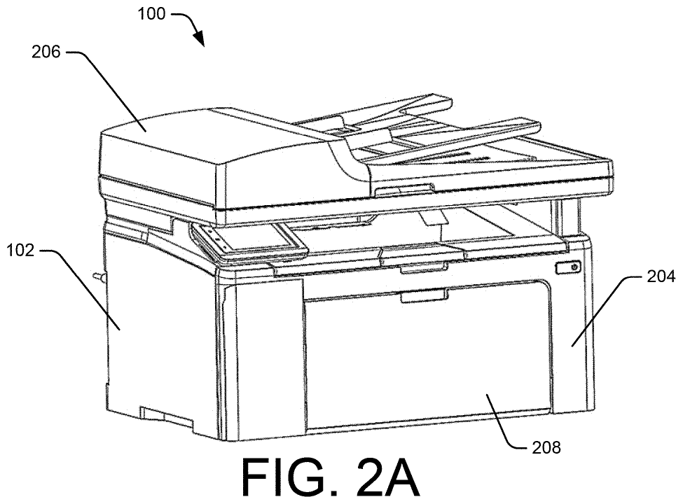

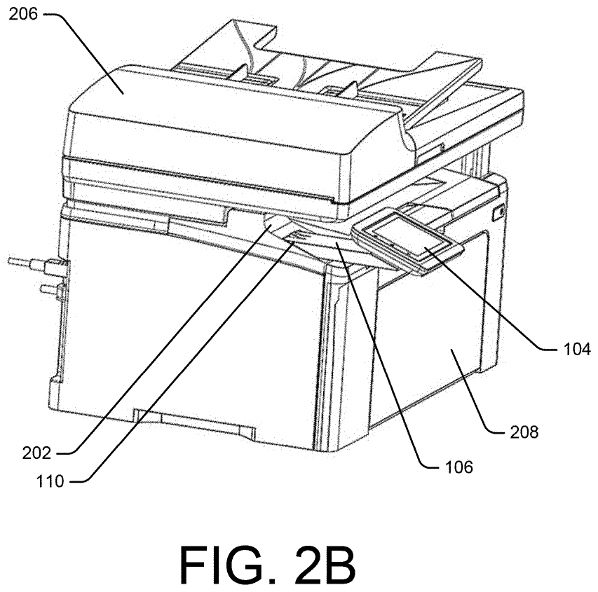

FIG. 2A and FIG. 2B illustrate perspective views of the imaging device 100, in accordance with an example of the present subject matter. While FIG. 2A illustrates a front perspective view of the imaging device 100, FIG. 2B illustrates a side perspective view of the imaging device 100. For the sake of brevity and ease of understanding, FIG. 2A and FIG. 2B are described in conjunction.

As mentioned above, the imaging device 100 is designed to accommodate the control panel 104 at the housing 102 in a manner that the imaging device 100 is not aesthetically affected and can, for example, be shipped conveniently without any fear of damage to the control panel 104. The control panel 104 is mounted to the housing 102 using the telescopic mount 106 which is slidably disposed in an opening 110 in the housing 102. The telescopic mount 106 is, accordingly, protractible and retractable with respect to the housing 102, thereby allowing the control panel 104 to be either withdrawn away from the housing 102 in the protracted position of the telescopic mount 106 or to be flush with the housing 102 in the retracted position of the telescopic mount 106.

In an example, the housing 102 can include a recess 202 at which the opening 110 for the telescopic mount 106 can be provided. In an example, the recess 202 can be provided in the housing 102 at the portion above a front-wall 204 under a top cover 206 of the imaging device 100. Accordingly, as shown in FIG. 2A, in a retracted position of the telescopic mount 106, the control panel 104 mounted thereon is flush with the recess 202 and hidden underneath the top cover 206. In such a position, the control panel 104 is protected from being damaged, for example, during transit as well as during use. Further, in the protracted position of the telescopic mount 106, shown in FIG. 2B, the control panel 104 can extend from under the top cover 206 for access by the user. In addition, the control panel 104 does not interfere with the other components, such as the front door 208, neither does the control panel 104 extend beyond the perimeter of the imaging device 100 keeping a clean aesthetic appeal of the imaging device 100 intact.

Further, as will be discussed in detail later, the telescopic mount 106 can have features which prevent the telescopic mount 106 from being withdrawn from the housing 102 in the protracted position, while, at the same time, lock the telescopic mount 106 with the housing 102 in the protracted position to prevent the telescopic mount 106 from being inserted back into the opening 110. As a result, in the protracted position of the telescopic mount 106, the control panel 104 remains fixed in one position so that when the user is operating the control panel 104, the control panel 104 is not pushed back towards the housing 102, for instance, due to the application of pressure by the user. Therefore, in other words, in the protracted position of the telescopic mount 106, the telescopic mount 106 is locked with the housing 102 to be able to withstand a threshold pressure applied by the user, without inadvertently unhinging from the housing 102.

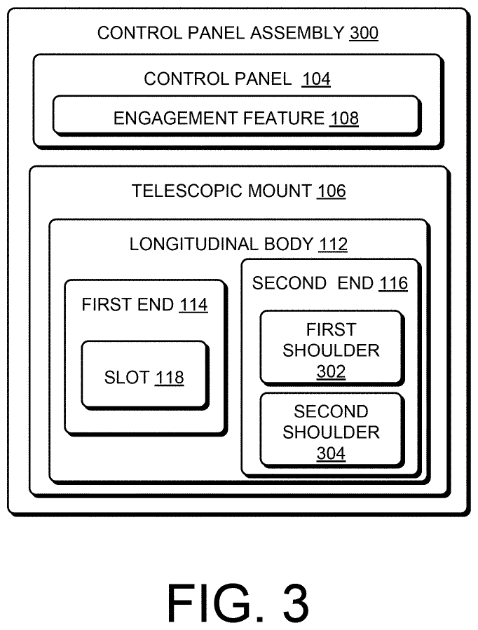

FIG. 3 illustrates a schematic of a control panel assembly 300, in accordance with an example of the present subject matter. As explained earlier, the control panel 104 can be coupled to the telescopic mount 106, thereby forming the control panel assembly 300. In said example, the control panel 104 includes the engagement feature 108 which can engage with a slot 118 at the first end 114 of the telescopic mount 106. At the second end 116, the telescopic mount 106 can be provided with a first shoulder 302 and a second shoulder 304 which form the locking feature 120 so as to lock the telescopic mount 106 with a support element, such as the housing 102 of the imaging device. Therefore, the control panel assembly 300, including the control panel 104 mounted to the telescopic mount 106, can cooperate with the opening 110 in the housing 102. In one example, the control panel 104 can be detachably coupled to the telescopic mount 106. However, in other examples, the control panel assembly 300 can be formed with the control panel 104 fixedly coupled to the telescopic mount 106. In both the cases, the control panel assembly 300 can be formed as a single, independent serviceable unit of the imaging device 100.

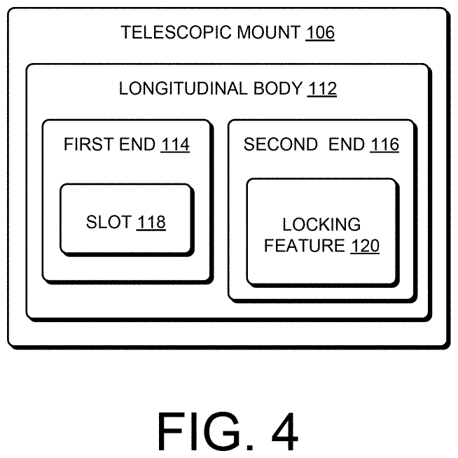

In addition, the telescopic mount 106 can be formed as a single, independent serviceable unit of the imaging device 100. FIG. 4 illustrates a schematic of the telescopic mount 106, in accordance with an example of the present subject matter. As mentioned previously, the telescopic mount 106 includes the longitudinal body 112 having the first end 114 and the second end 116. At the first end 114, the slot 118 forms a mating feature to detachably couple a component, such as the control panel 104, to the longitudinal body 112. At the second end 116, the locking feature 120, such as the first shoulder 302 and the second shoulder 304, is formed to lock the longitudinal body 112 with a support element, such as the housing 102.

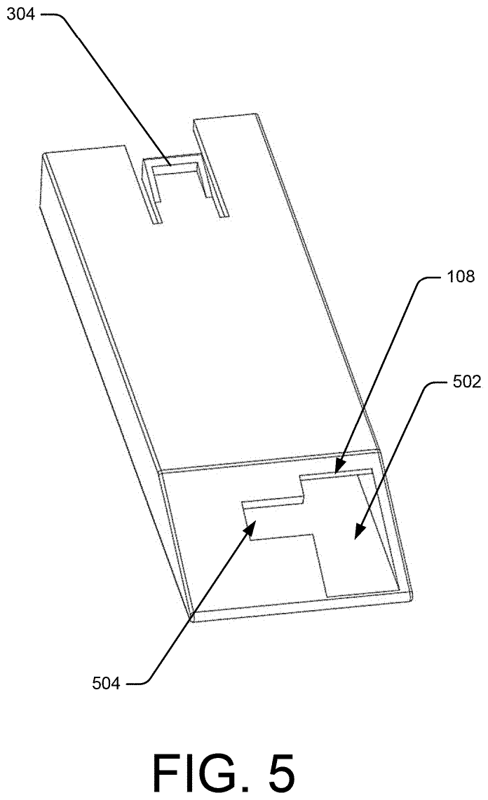

FIG. 5 illustrates a perspective view of the telescopic mount 106, according to an example of the present subject matter. In said example, the longitudinal body 112 of the telescopic mount 106 can be formed as having a hollow cross-section, for instance, designed to provide strength to the telescopic mount 106. The slot 118 provided at the first end 114, discussed with reference to FIG. 4 above, is formed as having a broad portion 502 and a narrow portion 504. For instance, the slot 118 can be formed as a cut-out at the first end 114 in the hollow longitudinal body 112. In addition, the slot 118 includes a snap-fit latching member (not shown), for instance, provided at the narrow portion 504 to detachably couple with the component, such as the control panel 104.

In addition, the first end 114 can be provided, as shown in FIG. 5, with a contour which can match a contour of the housing 102, for example, of the recess 202 of the housing 102. Accordingly, in the retracted position of the telescopic mount 106, the contour of the first end 114 matches with the contour of the housing 102, thereby forming an aesthetically pleasing surface. In addition, due to the matching contours, the control panel 104 can sit flush with the housing 102 in the retracted position of the telescopic mount 106.

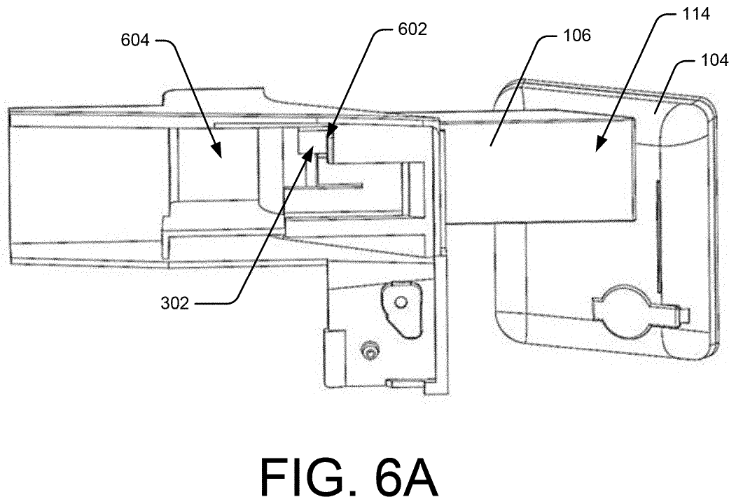

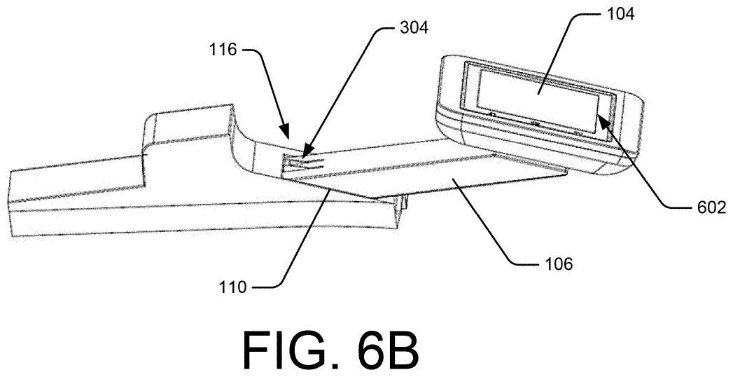

Further, as mentioned previously, the locking feature 120 includes the first shoulder 302 and the second shoulder 304. The structure and operation of the locking feature 120 is illustrated and discussed in detail with reference to FIG. 6A and FIG. 6B.

FIG. 6A and FIG. 6B, according to an example, illustrate a perspective view of the control panel assembly 300 assembled with the housing 102. As can be seen, in FIGS. 6A and 6B, a mounting portion of the housing 102 having the opening 110 to accommodate the control panel assembly 300 is shown instead of the entire housing 102.

FIG. 6A illustrates an operation of the first shoulder 302 of the telescopic mount 106 provided at the second end 116 of the longitudinal body 112. As shown, in a protracted position of the telescopic mount 106, the first shoulder 302 may lock with the housing 102 to prevent the telescopic mount 106 from being withdrawn from the housing 102 when the telescopic mount 106 is pulled away from the housing 102 from a retracted position, for example, by a user for operating the control panel 104 mounted thereon. For example, the housing 102 can have a projection 602 formed on an inner surface 604 of the housing 102, for instance, the surface facing the various components housed in the housing 102. As the control panel 104 mounted on the telescopic mount 106 is pulled by the user for operation, when the telescopic mount 106 reaches the protracted position, the first shoulder 302 can engage with the projection 602 on the housing 102 to prevent the telescopic mount 106 from being withdrawn completely from the housing 102.

Further, FIG. 6B illustrates the second shoulder 304 of the telescopic mount 106. In a protracted position of the telescopic mount 106, the second shoulder 304 can abut against an edge of the opening 110 of the housing 102, which in turn prevents the telescopic mount 106 from being inserted into the housing 102, for instance, when a user operates the control panel 104. For instance, in operating the control panel 104, the user may apply pressure on a front surface 606 of the control panel 104 which may push the control panel 104 towards the housing 102. By the provision of the second shoulder 304, the telescopic mount 106 is locked with the housing 102 against being inadvertently inserted back into the housing 102, thereby providing an ease-of-use for the user.

In addition, in one example, the telescopic mount 106 can include a plurality of swivel pins (not shown) provided at the second end 116. The swivel pins can extend substantially orthogonally with respect to a longitudinal axis of the longitudinal body 112. In other words, the swivel pins can extend perpendicular to the length of the longitudinal body 112. Each swivel pin can cooperate with a groove provided in the housing 102, such that the swivel pins are engaged with the grooves in the housing, in the protracted position of the telescopic mount, for allowing pivoting of the longitudinal body 112 with respect to the housing 102. For example, at the protracted condition of the telescopic mount 106, when the second shoulder 304 is locked with the edge of the opening 110, the telescopic mount 106 can be swiveled about the swiveling pins to unlatch the second shoulder 304 and allow insertion of the telescopic mount 106 into the opening 110 to the retracted position.

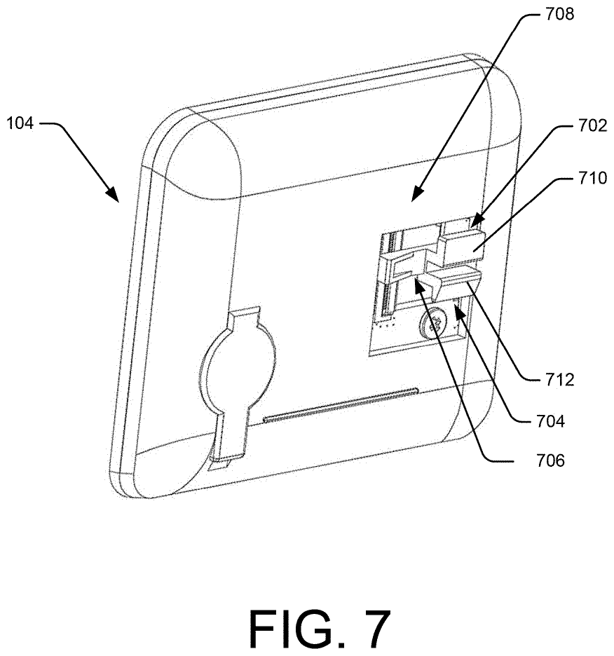

Further, as mentioned previously, at the first end 114 of the longitudinal body 112, the control panel 104 can be mounted. The structure and mounting of the control panel 104 to the telescopic mount 106 is described in detail with reference to FIG. 7 onwards.

FIG. 7 illustrates a rear perspective view of the control panel 104 for the imaging device 100, according to an example of the present subject matter. For instance, FIG. 7 illustrates the example in which the control panel 104 is detachably coupled to the telescopic mount 106. In said example, the control panel 104 can include the engagement feature 108 which can cooperate with the slot 118 in the first end 114 of the telescopic mount 106. In one example, the engagement feature 108 can include a plurality of ears 702, 704 for slidable engagement of the control panel 104 with respect to the slot 118. Each ear 702, 704 can include a base 706 connected to a wall 708 of the control panel 104 and a fin 710, 712 curved to be substantially parallel to the wall 708 of the control panel 104 to form a guiding channel. The ears 702, 704 are insertable into the broad portion 502 of the slot 118 in the longitudinal body 112 and the guiding channels formed by the ears 702, 704 can be slidable along an edge of the narrow portion 504 of the slot 118.

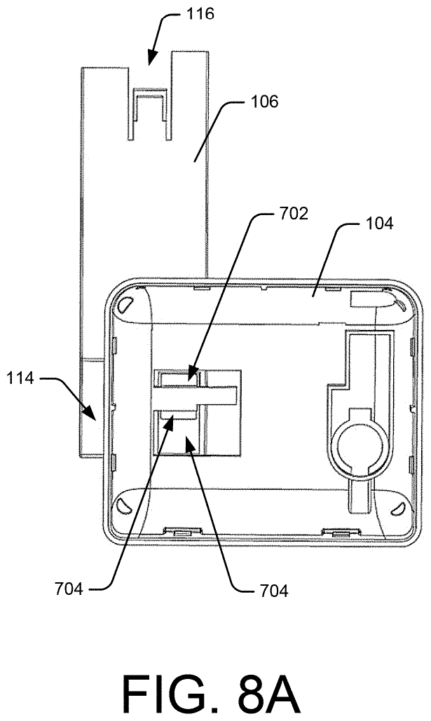

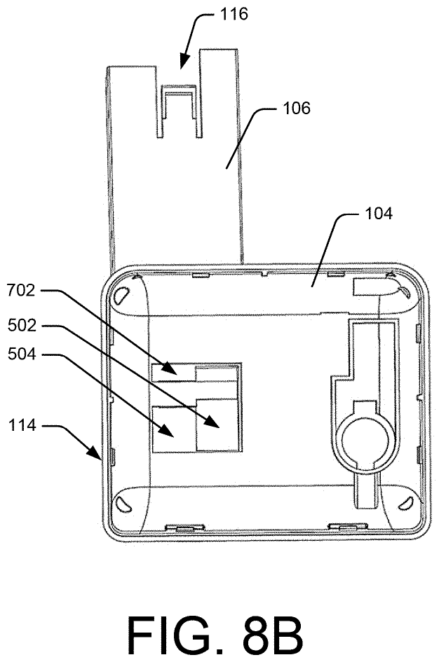

FIG. 8A and FIG. 8B illustrate the assembly of the control panel 104 and the telescopic mount 106, according to an example of the present subject matter. As shown in FIG. 8A, the ears 702, 704 are inserted into the broad portion 502 of the slot 118 in the first end 114. Further, the ears 702, 704 can be slid along the narrow portion 504 so as to lock the control panel 104 with the snap-fit latching member of the slot 118. In an example, the engagement feature 108 of the control panel 104 can include a complementary latch (not shown) which can lock with snap-fit latching member in the slot 118. In other words, the control panel 104 can glide on the guiding channel along the narrow portion 504 of the slot 118, in a similar manner as guides slide along guide rails. Once at the penultimate position, the control panel 104 can be provided a push to latch the snap-fit latching member with the complementary latch, as shown in FIG. 8B.

Although aspects of the telescopic mount 106 for the imaging device 100 have been described in a language relevant to structural features and/or methods, it is to be understood that the present subject matter is not limited to the features or methods described herein. Rather, the features and methods are disclosed as examples of the telescopic mount 106.

I/We claim:

1. A telescopic mount for an imaging device, the telescopic mount comprising:
a longitudinal body having a first end and a second end opposite to the first end;
a slot forming a mating feature at the first end to detachably couple a component to the longitudinal body; and
a locking feature at the second end to lock the longitudinal body with a support element.

2. The telescopic mount as claimed in claim 1, wherein the slot is formed as having a broad portion and a narrow portion, wherein the slot comprises a snap-fit latching member to detachably couple to the component.

3. The telescopic mount as claimed in claim 1, further comprising a plurality of swivel pins provided at the second end, wherein the swivel pins extend substantially orthogonally with respect to a longitudinal axis of the longitudinal body.

4. A control panel assembly for an imaging device, the control panel assembly comprising:
a control panel comprising an engagement feature; and
a telescopic mount comprising,
a longitudinal body having a first end and a second end opposite to the first end;
a slot forming a mating feature at the first end to couple to the engagement feature of the control panel; and
a first shoulder and a second shoulder to form a locking feature at the second end to lock the telescopic mount with a support element.

5. The control panel assembly as claimed in claim 4, wherein the longitudinal body comprises a plurality of swivel pins provided at the second end, wherein the swivel pins extend substantially orthogonally with respect to a longitudinal axis of the longitudinal body.

6. The control panel assembly as claimed in claim 4, wherein the slot is formed as having a broad portion and a narrow portion, wherein the slot comprises a snap-fit latching member to detachably couple with the control panel.

7. The control panel assembly as claimed in claim 6, wherein the engagement feature of the control panel comprises a plurality of ears for slidable engagement of the control panel with respect to the slot, each of the plurality of ears comprising a base connected to a wall of the control panel and a fin curved to be substantially parallel to the wall of the control panel to form a guiding channel.

8. The control panel assembly as claimed in claim 7, wherein the plurality of ears is to be insertable into the broad portion of the slot in the longitudinal body, and wherein the guiding channel is to be slidable along an edge of the narrow portion of the slot, the engagement feature further comprising a complementary latch to lock with the snap-fit latching member of the slot.

9. An imaging device comprising:
a housing comprising an opening;
a control panel to be mounted to the housing, the control panel comprising an engagement feature; and
a telescopic mount disposed in the opening in the housing, the telescopic mount comprising,
a longitudinal body having a first end and a second end opposite to the first end, the telescopic mount being telescopically slidable with respect to the housing along the longitudinal body;
a slot forming a mating feature at the first end to detachably couple to the engagement feature of the control panel; and
at the second end, a locking feature to lock the longitudinal body with the housing in a protracted position of the telescopic mount.

10. The imaging device as claimed in claim 9, wherein, in a retracted position of the telescopic mount, a contour of the first end matches a contour of the housing.

11. The imaging device as claimed in claim 9, wherein the locking feature comprises a first shoulder to abut against a projection on the housing to prevent the telescopic mount from being withdrawn from the housing in the protracted position of the telescopic mount.

12. The imaging device as claimed in claim 9, wherein the locking feature comprises a second shoulder to abut against an edge of the opening of the housing to prevent the telescopic mount from being inserted into the housing in the protracted position of the telescopic mount.

13. The imaging device as claimed in claim 9, wherein the slot is formed as having a broad portion and a narrow portion, wherein the slot comprises a snap-fit latching member to detachably couple with the control panel.

14. The imaging device as claimed in claim 13, wherein the engagement feature of the control panel comprises a plurality of ears for slidable engagement of the control panel with respect to the slot, each of the plurality of ears comprising a base connected to a wall of the control panel and a fin curved to be substantially parallel to the wall of the control panel to form a guiding channel.

15. The imaging device as claimed in claim 14, wherein the plurality of ears is to be insertable into the broad portion of the slot in the longitudinal body, and wherein the guiding channel is to be slidable along an edge of the narrow portion of the slot, the engagement feature further comprising a complementary latch to lock with the snap-fit latching member of the slot.
